(19) United States
(12) Patent Application Publication
(10) Pub. No.: US 2014/0063025 A1
(43) Pub. Date: Mar. 6, 2014

(54) Pipelined Image Processing Sequencer

(71) Applicant: Scott A. Krig, Santa Clara, CA (US)

(72) Inventor: Scott A. Krig, Santa Clara, CA (US)

(21) Appl. No.: 13/993,767

(22) PCT Filed: Dec. 28, 2011
(86) PCT No.: PCT/US2011/067455

§ 371 Date: Jun. 13, 2013

(51) Int. Cl. G06T 1/20

(52) U.S. Cl. CPC G06T 1/20
USPC 345/506

(57) ABSTRACT

To provide optimal power and performance policy choices for imaging and analytic processing, In accordance with some embodiments, reusable, reconfigurable, dedicated function process elements may be allocated to execution sequences made up of sequentially executed process elements. Any given process element may be reconfigured in any given execution sequence to meet a sequence performance metric. A plurality of sequences may then run in parallel.

### BACKGROUND

This relates generally to performing processing tasks for image processing and analytics.

Analytics involves processing images or video sequences made up of image frames to obtain information about depicted objects. Video analytics is commonly used in a variety of applications, including surveillance, facial recognition, and video searching, to mention a few examples.

Video analytics applications tend to be compute and memory intensive and, in some cases, both fixed function hardware blocks are combined with software components. Typically, common functions may be executed a number of times, including items like calculating thresholds, fast Fourier transforms, histograms, or spatial convolutions, to mention a few examples.

Image processing includes analytics, as well as enhancements and adjustments to pictures from cameras, scanners, and existing image or video files.

### BRIEF DESCRIPTION OF THE DRAWINGS

Some embodiments are described with respect to the following figures:

FIG. 1 is a schematic depiction of one embodiment of the present invention;

FIG. 2 is a flow chart for one embodiment;

FIG. 3 is a system depiction for one embodiment; and

FIG. 4 is a depiction of an embodiment in the form of a mobile device.

### DETAILED DESCRIPTION

In accordance with some embodiments, reusable, reconfigurable, dedicated function process elements for image processing may be allocated to execution sequences made up of sequentially executed process elements. Any given process element may be reconfigured in any given execution sequence to meet a sequence performance metric. A plurality of sequences may then run in parallel.

As used herein, a “process element” may be a software or hardware module that performs a particular computing task. Examples of process elements in video analytics applications include fast Fourier transforms, threshold, morphology, histogram, spatial convolution, colorimetry, lookup table, format transformation, template matching, programmable single instruction multiple data, shape factors, scene statistics, and three-dimensional wire frame meshes.

An execution sequence is a chain of serially executed process elements.

A process element may be reusable in that the element is dedicated to a particular function and may be reused in one or more execution sequences at different times or in parallel. Process elements may be reconfigurable in that they may be adapted at run time to achieve specific operating conditions or design constraints. Particularly, any given process element may be reconfigured to meet a performance metric associated with the particular sequence in which it currently is placed.

As examples of performance metrics, a given sequence may have a power consumption or power budget goal. The operation of particular process elements within that sequence may be modified, for purposes of that particular sequence only, in order to meet a performance metric.

As another example, the performance of individual process elements may be modified to improve the speed of the sequence. For example, the bandwidth for memory accesses may be increased or decreased to improve performance or to modulate power consumption.

As still another example, the characteristics or operation of any given process element may be changed to achieve a desired operating temperature range. For example, the voltage or frequency of a hardware based process element may be modified in a particular sequence to meet a temperature limitation.

As still another example, the speed (in operations per second, for example) at which a given process element operates may be modified to achieve either performance, speed, or power consumption goals.

As yet another example, the priority of any given process element within an execution sequence or the sequence as a whole may be modified in order to meet sequence level goals, such as operational speed. In particular, a memory access priority of a process element or a sequence may be changed to achieve a performance metric.

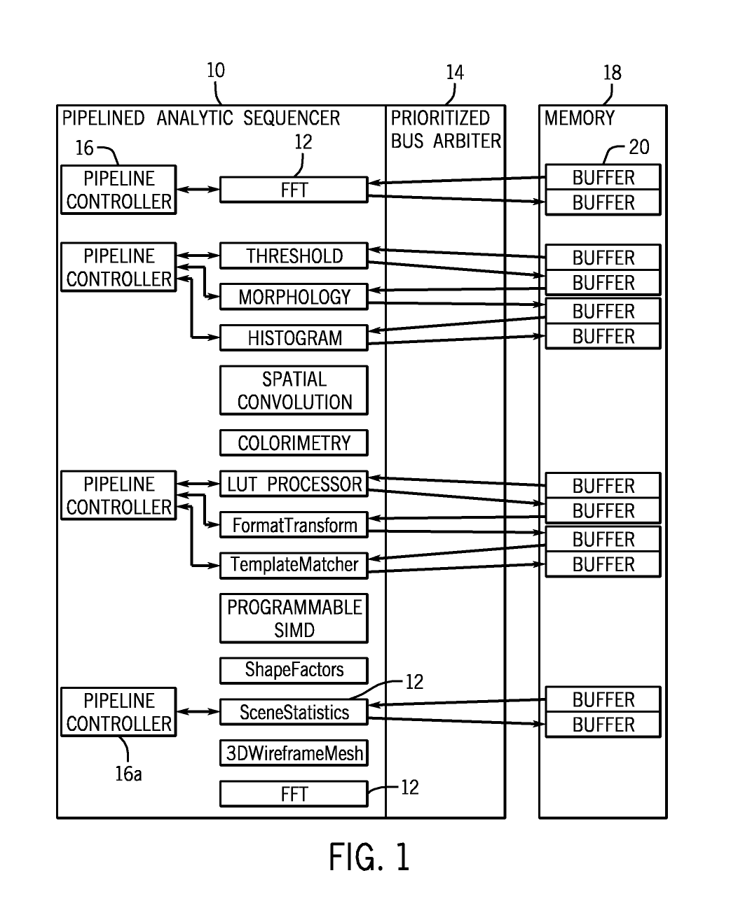

Referring to FIG. 1, a pipeline analytics sequencer 10 may include a plurality of reusable, reconfigurable, dedicated function process elements 12 that form one or more sequences and a prioritized bus arbiter 14. In addition, the sequencer 10 may include a number of pipeline controllers 16 which, in one embodiment, may be separate hardware controllers. The pipelined analytics sequencer 10 may communicate over a bus with a memory 18 that is made up of a number of addressable buffers 20. In an embodiment, the sequencer may be implemented as one or more software processes or tasks using a general purpose computer, so that the functionality is the same whether a software, hardware or a combination of both is used.

Thus, each of the process elements 12 may be either a hardware or software module that does a specific dedicated function. Still, it may be reused in more than one execution sequence at a time and may have its operating characteristics adjusted to meet particular sequence operational goals.

In some embodiments, each sequence may be made up of one or more process elements controlled by a pipeline controller 16. Thus, as shown in FIG. 1, the pipeline controller 16 controls a single element 12 sequence made up of a fast Fourier transform element 12, as one embodiment. Similarly, the pipeline controller 16a may include three process elements 12, including the fast Fourier transform process element 12. In some cases, the pipeline controller 16 and the pipeline controller 16a may execute sequences that run in parallel, even though they both use some of the same process elements 12. To this end, the prioritized bus arbiter 14 arbitrates disputes and contentions for process elements and memory locations used by more than one concurrently operating sequence.

The sequencer 10 may be controlled using a variety of methods. According to one method, it is controlled by a protocol that sends and receives extensible markup language (XML) commands over a communication link or bus. In another embodiment, the sequencer may be controlled by memory mapped control and status registers (CSR). In still another embodiment, the sequencer may be controlled by a command queue or ring buffer containing commands similar to a control and status register format or an extensible markup format.

In some embodiments, each execution sequence has a unique identifier. Moreover, the order of execution of the process elements within the sequence is also determined by assigning identifiers to each process element and by recording a ordered list of process element identifiers.

In one embodiment, the arbiter 14 enforces a first come, first served arbitration protocol. If two execution sequences want to use the same process element, each must wait to use the process element until that element is free, in one embodiment. When a process element is executing, the sequence may stall and wait until the process executes to completion or has an error state. Then, the sequence continues executing all process elements in the chain until they are all complete.

In some embodiments using command and status registers, each sequence is responsible for programming the command and status registers for each process element in the chain to execute correctly. Each sequence may check the status of each process element in the sequence as needed.

Each process element may be programmed via control and status registers to use an input buffer and an output buffer. These buffers may reside in any type of memory. Control may also be accomplished using software and function calls into a software library that implements the controllers and sequencer.

A pipeline controller 12 may reserve a processing element. When reserved, no other sequence can use the process element until the process element is set to free. A process element can only be freed by the owning sequence in one embodiment. A sequence may also use a process element without reservation, using a first come, first served arbitration model, since process elements may be shared between sequences unless the process elements are reserved.

In some embodiments, a sequence or a process element may be assigned a power state that is a predefined calibration of voltage and frequency. For example, a low power state may have a reduced clock and voltage requirement. For each process element, a set of programmable power states may be available as presets, such as off, standby, low, medium, and high. If a process element is not used, the sequence may turn it off or turn it to a standby mode. Then the process element operates at the given power state. A power budget assigned to a sequence may change the power state, clock rate or voltage of any given process element to achieve a given performance target.

In an embodiment shown in FIG. 1, when a process element accesses a buffer 20, the buffer may send an input to a process element 12, which may process the input and provide an output back to a different buffer 20. However, in other cases, such as in an execute-in-place embodiment, the output may return to the same buffer that provided the input.

A number of different registers may be implemented in a control and status register implemented embodiment. For example, a register called a sequence master control and status register may have sequencer controls implemented by specific patterns of bits that set a reset state or a write only state, an off state, and an on state where reading and writing is possible, as well as a start command and a stop command.

Another register, which may be called a sequencer pipeline status register, controls the starting and stopping of each sequence. A sequence is first set up using a pipeline setup register and then pipeline control registers. The sequencer pipeline status registers may be start or stop indicators.

Each process element may include a setup register which may receive a number of different words, including an input buffer address, an input buffer size, an output buffer address, an output buffer size, a sequence identifier of the controlling sequence, a power budget, a memory arbitration priority, a radix for a fast Fourier transform process element, and other parameters for any given process element. A setup area for each process element may specify input and output buffers and other parameters, including power budget and memory arbitration priority. In one embodiment, a process element may have various arrangements of setup parameters.

Each process element may have a command and status register as well, which may be controlled by the sequence that controls that particular process element. A sequence may reserve a process element so that no other sequence may use the process element until the sequence sets the process element free. This register may include words with information like the power state, an output results code, a reset indicator, start and stop indicators, and status bits including but not limited to process complete, percentage complete, wait on memory operation bit, a processing in progress bit, as well as various error bits.

Then each process element may have a setup register and a control and status register and each sequence may have a setup register and a control and status register. The setup sequence register may include a sequential list of process element identifiers forming the sequence chain. The process elements may be executed in the context of a sequence in the order given in the chain. Process elements may be shared amongst sequences with arbitration based on first come, first served, in one embodiment. In some embodiments, the sequence may be run by a pipeline controller which is a simple microcontroller that actually sequences each process element. The process element completion status may be sent to its owning sequence that then starts other process elements in the sequence as needed and records status in command and status registers.

In some embodiments, a sequence 22 may be implemented in software, firmware, and/or hardware. In software and firmware embodiments, it may be implemented by computer executed instructions stored in a non-transitory computer readable medium, such as a magnetic, optical, or semiconductor storage.

In one embodiment, the sequence 22 may begin by allocating process elements for one execution sequence. The process elements in the sequence may be reconfigured to meet a performance metric, as indicated in block 26. Then, two or more sequences, made up of process elements, may be run in parallel, as indicated in block 28.

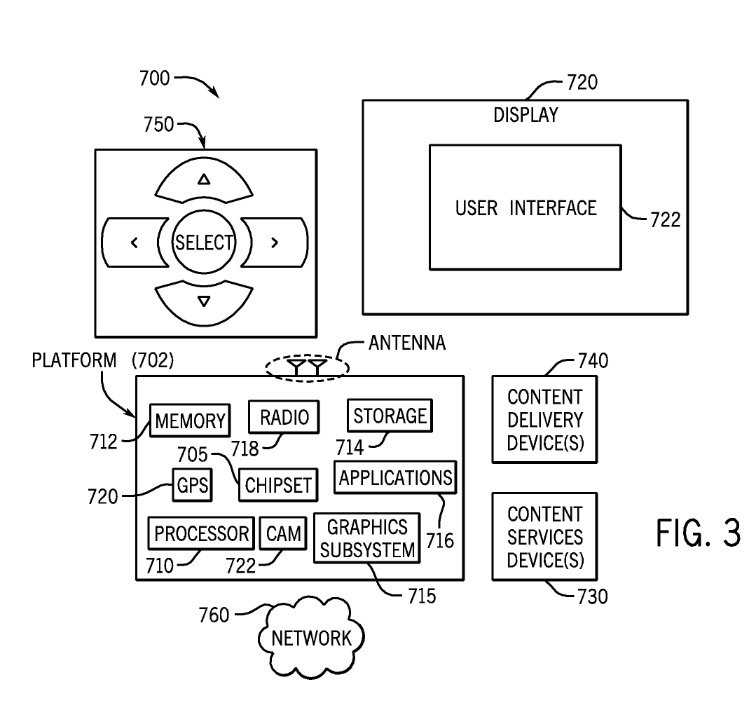

FIG. 3 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

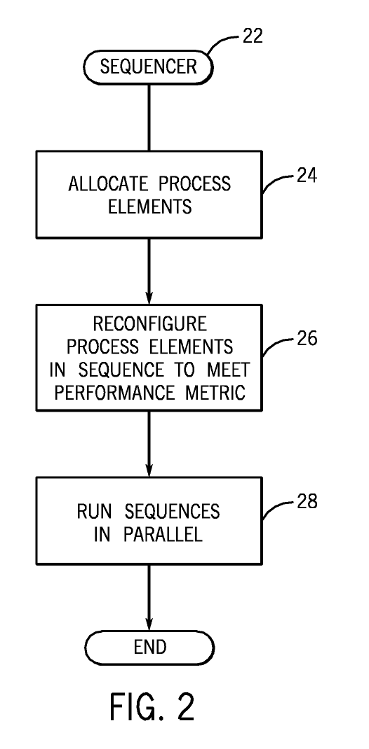

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 2.

As described above, system 700 may be embodied in varying physical styles or form factors. FIG. 3 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

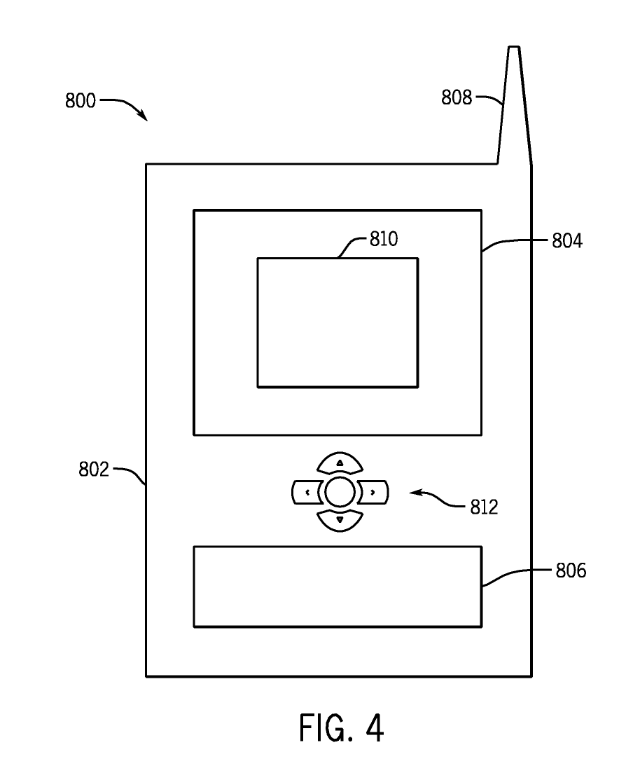

As shown in FIG. 4, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
allocating reusable, reconfigurable, dedicated function image processing process elements to an execution sequence of process elements;
reconfiguring a process element in a sequence to meet a sequence performance metric; and
running a plurality of sequences in parallel.

2. The method of claim 1 including using a given process element in two sequences run in parallel.

3. The method of claim 1 wherein reconfiguring includes modifying a process element to meet a sequence power budget.

4. The method of claim 3 wherein reconfiguring includes adjusting memory bandwidth to regulate power consumption.

5. The method of claim 1 including adjusting one of voltage or frequency of a process element to control temperature or performance.

6. The method of claim 1 including adjusting operations per second of a process to meet a sequence performance metric.

7. The method of claim 1 including adjusting the priority of a process element to meet a performance metric or bus arbitration metric of its sequence.

8. The method of claim 1 including changing at run time how a process element operates in a sequence to meet a performance metric.

9. The method of claim 1 including altering a memory access priority level of a process element to meet a sequence performance metric.

10. The method of claim 1 wherein reconfiguration is dynamically implemented during the sequence.

11. A non-transitory computer readable medium storing instructions to enable a processor to:
allocate reusable, reconfigurable, dedicated function image processing process elements to an execution sequence of process elements;
reconfigure a process element in a sequence to meet a sequence performance metric; and
run a plurality of sequences in parallel.

12. The medium of claim 11 further storing instructions to use a given process element in two sequences run in parallel.

13. The medium of claim 11 further storing instructions to modify a process element to meet a sequence power budget.

14. The medium of claim 13 further storing instructions to adjust memory bandwidth to regulate power consumption.

15. The medium of claim 11 further storing instructions to adjust one of voltage or frequency of a process element to control temperature or performance.

16. The medium of claim 11 further storing instructions to adjust operations per second of a process to meet a sequence performance metric.

17. The medium of claim 11 further storing instructions to adjust the priority of a process element to meet a performance metric or bus arbitration metric of its sequence.

18. The medium of claim 11 further storing instructions to change at run time how a process element operates in a sequence to meet a performance metric.

19. The medium of claim 11 further storing instructions to alter a memory access priority level of a process element to meet a sequence performance metric.

20. The medium of claim 11 further storing instructions to dynamically implement reconfiguration during the sequence.

21. An apparatus comprising:
a sequencer to allocate reusable, reconfigurable, dedicated function image processing process elements to an execution sequence of process elements, reconfigure a process element in a sequence to meet a sequence performance metric, and run a plurality of sequences in parallel; and
a memory coupled to said sequencer.

22. The apparatus of claim 21, said sequencer to use a given process element in two sequences run in parallel.

23. The apparatus of claim 21, said sequencer to modify a process element to meet a sequence power budget.

24. The apparatus of claim 23, said sequencer to adjust memory bandwidth to regulate power consumption.

25. The apparatus of claim 21, said sequencer to adjust one of voltage or frequency of a process element to control temperature or performance.

26. The apparatus of claim 21, said sequencer to adjust operations per second of a process to meet a sequence performance metric.

27. The apparatus of claim 21, said sequencer to adjust the priority of a process element to meet a performance metric or bus arbitration metric of its sequence.

28. The apparatus of claim 21, said sequencer to change at run time how a process element operates in a sequence to meet a performance metric.

29. The apparatus of claim 21, said sequencer to alter a memory access priority level of a process element to meet a sequence performance metric.

30. The apparatus of claim 21 including a wireless interface.
